(19) United States
(12) Patent Application Publication
(10) Pub. No.: US 2024/0047132 A1
(43) Pub. Date: Feb. 8, 2024

(54) Micro-Stepping Cascading AC Voltage Regulator

(71) Applicants: David Baretich, Wilsonville, OR (US); Gregory P. Wiegand, Poulsbo, WA (US)

(72) Inventors: David Baretich, Wilsonville, OR (US); Gregory P. Wiegand, Poulsbo, WA (US)

(21) Appl. No.: 17/878,805

(22) Filed: Aug. 1, 2022

(51) Int. Cl. H01F 29/04; H01H 9/00; H01F 29/02

(52) U.S. Cl. CPC H01F 29/04; H01H 9/0005; H01F 29/025

(57) ABSTRACT

A tap changing regulator with at least one regulator stage that has a set of input taps and a set of switches in a switching matrix. The have respective on-off modes to connect one or more of the taps to an output voltage to effect a number of regulation steps, where the ratio of the number of regulation steps to the number of taps is always greater than 1:1. The regulator taps are spaced between sets of windings having a progressive windings ratio of 1 to 3 to 2, or integer multiples of that ratio. Series connected additional regulator stages have an input tap with a windings ratio that is twice the sum of the first stage regulation steps, plus 1.

### TECHNICAL FIELD

This application claims priority to U.S. patent application Ser. No. 15/959,204 filed Apr. 21, 2018 which claims priority to U.S. Provisional Patent application 62/488,305 filed Apr. 21, 2017 both of which are hereby incorporated by this reference as if fully set forth herein.

### BACKGROUND OF THE INVENTION

Historically a common form of AC voltage regulation has been provided by so called tap changing regulators. These are used in a variety of applications, from low voltage AC regulation for individual appliances, up to medium and high voltage utility transformers. They are some of the simplest regulators in terms of circuit complexity. However, they suffer from either lack of sufficient regulation granularity for many applications, or sufficient regulating range.

For a typical tap changer using electronic switches (such as thyristor, MOSFET, IGBT, see FIG. 1), a transformer tap and a bidirectional switch is required for each step in voltage. For example, some regulators will limit to five taps at 2% intervals (reference Legend Power Systems) for a typical regulating range of +2% to −6% of input voltage. Other regulators regulate over a wider voltage range, but with very coarse regulations steps of more than 10% (reference Koblenz, Tripp-Lite).

Medium voltage utility tap changing transformers typically use mechanical tap switching mechanism and can implement half-taps. This reduces the number of required taps approximately in half. However, mechanical tap changers are slow in response and wear out over time. For reference, a typical utility regulator might have 16 taps, with half-taps at 0.625%, for a total of +/−10% regulation range. An electronic version with this capability will require 33 taps and 33 electronic switches. That is, 16 each positive, 16 each negative, and one for 0%.

Coarse regulation, while better than nothing, still has significant disadvantages regarding power quality. A large step voltage (1% or greater) on the output can cause detectable flicker in downstream lighting and cause VAR compensating capacitors to resonate. Because of this, the frequency of tap changes and their step size is typically minimized. Both of these considerations are becoming larger issues as utilities are forced to integrate ever increasing amounts of reverse power flow from Distributed Energy Resources (DER) which creates a new class of voltage compliance problems.

A second issue is the inability to optimize voltage as precisely as desired. A third issue is the inability of a coarsely regulated tap changer to provide precise control within each cycle to correct the AC waveform, reduce harmonics, and dampen resonances in the AC system.

Electronic power controllers and inverters have eliminated this lack of granularity and slow response by using high frequency pulse width modulation (PWM) techniques. However, these controllers are more complex and create radio frequency interference that must then be filtered. Because the largest and highest voltage electronic switches available are typically not as fast as smaller ones, the maximum power capability of PWM designs is limited as a practical matter. Furthermore, because of high frequency switching losses and inductor core losses, efficiency is reduced. So for many applications, a tap changing regulator would be an attractive option if it were made to respond with similar speed and precision as that of a high frequency converter.

Another issue where improvement is needed, is commutation of switches in tap changing regulators. With electronic switches such as IGBTs, MOSFETs, and thyristors with turn-off capability, this normally involves turning off one tap before turning on the next one (dead time). However, it leaves no path for current to travel during the dead time, resulting in excessive voltage across the switches. Typically, some sort of voltage clamp or snubber is used to limit voltage on the switches during this dead time. However, snubbers and clamps add cost and often exhibit excessive power dissipation, especially when switching at higher rates (multiple times per cycle). It would therefore be highly beneficial to have a commutation method for multiple tap changing regulators that does not require voltage clamps or snubbers, and has reduced power dissipation.

None of these issues have been adequately, if at all, addressed in the prior art. For example, U.S. Pat. No. 5,373,433 ('433) to Trace Engineering shows an inverter application where successive voltage steps and stages of smaller size can be added and subtracted to gain finer resolution of the output voltage in the inverter. However, each stage has only +/−1 step in capability. This limits the effective resolution gain of each additional section implemented or cascaded in the inverter. U.S. Pat. No. 8,035,358 to Superior Electric shows an AC regulator based upon a similar idea. However, it has the same limitations as '433 in that a larger number of switch stages are still required to achieve the higher number of steps.

Other known topologies and disclosures have similar shortcomings and disadvantages with respect to desired outcomes and topologies. For instance, U.S. Pat. No. 6,750,563 discloses a semi-high frequency PWM with only one bidirectional switch on one tap and one other switch on the other tap. WO2017-171540 discloses only capacitor based voltage multipliers. U.S. Pat. No. 9,123,464 discloses improved transient protection and 10+/−steps with 10 switches.

The IEEE Recommended Practice for Electric Power Distribution for Industrial Plants, published 1994 Apr. 29, reaffirmed 1999 Mar. 18, withdrawn 2021 Mar. 25) (See Electronic Tap-changer for Distribution Transformers, Jawad Faiz, Behzad Siahkolah; Springer Publishing, 2011.) discloses figures 1.25, 1.28 and 2.16 (respectively application FIGS. 2A, 2B and 2C) which are schematic representations of known regulator switch topologies.

FIG. 2A shows a set of taps of 1.25%/2.5%/5%/1.25%, for a 1/2/4/1 ratio set. That gives it a total of 8 steps from 10 bidirectional switches. Its step-to-switch ratio is thus less than unity (less than 1:1).

FIG. 2B shows 5.5 pairs (11 switches total) of bidirectional switches to get 6 steps in a 0/3/1/2 (2 separate windings) transformer ratio with electronic tap-changer configuration with ±10%. This step-to-switch ratio is thus less than unity.

FIG. 2C shows a basic tap and switch set that is cascaded to multiple taps, but still has less than desirable step-to-switch ratios.

In summary, it would therefore be highly beneficial to have a tap changing regulator that uses significantly fewer taps and switches to accomplish a desired regulation range and precision. In other words, a tap changing regulator with a greater number of micro-steps in regulation range than the number of switches or taps employed to effect the full regulation range. This relationship can be stated as a ratio of steps to switches or steps to taps that is greater than unity, or 1:1. Desirably, the ratio would be greater than 2:1 and advantageously greater than 4:1.

It would also be further beneficial for that tap changing regulator to have precision and response time that is similar to high frequency modulated converters such as inverters and direct AC-AC converters.

### DISCLOSURE OF THE INVENTION

A surprising and unique combination and topology of transformer voltage taps and switches is disclosed to create a much larger number of voltage steps than would be predicted or provided by a given number of switches in conventional tap changing regulators. This larger number of voltage steps allows for smaller adjustment steps (micro-stepping) and/or a wider total adjustment range in a tap changing regulator, thus providing significant advantages in terms of reduced parts count, simplified magnetics, increased reliability, and all of these with faster and more precise regulation.

For the purposes of this application, a “switch” (including electronic switches) is defined as a bidirectional switch that may be made up of thyristors, MOSFETs, IGBTs, BJTs, or any other electronically controllable switch, including gas discharge tubes as well as any other such technology now known or later developed. If the switch employed in disclosed systems is a semiconductor, a bi-directional switch is composed of a pair of semiconductor switches (see FIG. 1) conventionally oriented with respect to one another. A switch may employ silicon, silicon carbide, (SiC) gallium nitride (GaN), as well as any other such semiconductor now known or later developed. Mechanical switches such as relays or contactors are contemplated in some cases as well.

Low voltage AC is generally voltage below 1000 VAC, in either single phase or three phase configurations. It may be 50 Hz, 60 Hz, or 400 Hz or more for aircraft or similar operation. Medium voltage AC is generally in the range of 1000 VAC to 38 kVAC. High voltage AC is generally above 38 kVAC.

In this application all switches, mechanical, electronic, semiconductor, or otherwise, are represented by a simple switch symbol because the disclosed technology works with many kinds of switches, and to simplify the schematics for ease of discussion. Examples of bidirectional switches using some known forms of electronic switches are provided in FIG. 1.

For the purposes of this application a transformer tap is defined as a conductor that allows an electrical connection to be made at some point in the transformer winding. For example, FIG. 4 shows a schematic with four taps on the transformer secondary.

For the purposes of this application one regulator ‘step’ is defined as an increase or decrease of the output voltage relative to the nominal input voltage, sometimes further defined as some percentage of the input voltage. Typically, ‘step’ describes both positive and negative effects, unless otherwise defined as asymmetrical. For example, a three step regulator provides three positive steps, an null point, and three negative steps.

FIG. 3A shows a conventional tap changing regulator schematic. It has 7 output taps and 7 switches and a regulating range of only +3 steps, 0% step, and −3 steps. FIG. 3B shows a known tap changing regulator that has a total of 13 taps and 13 switches a regulating range of only +6 steps, 0% step, and −6 steps. These known examples show a ratio of steps to switches that is no better than unity (1:1) and generally less.

The ratio of micro-steps to switches or to taps novelly disclosed herein is always greater than 1:1, up to 2:1 and 4:1 and even greater depending on the design requirements.

Voltage taps and electronic switches are disclosed in unique configurations, along with a novel and advantageous commutation method. These configurations increase the number of regulation steps within in a given voltage range, as compared with the number of taps and switches used in conventional topologies for the same or similar ranges. Furthermore, these unique configurations are beneficial when different stages are cascaded, the cascade having for example a combination of larger steps and smaller ones, thus effecting an even greater multiplication of steps per tap and switch as well as smaller step sizes (smaller voltage steps than in conventional devices).

### Micro-Stepping Regulator Examples

A tap changing regulator is disclosed with at least one regulator stage that has a set of input taps and a set of switches in a switching matrix. The switches are selectively and individually engagable in respective on-off modes to connect one or more of the taps to an output voltage to effect a number of voltage regulation steps. The ratio of the number of regulation steps to the number of taps is always greater than 1:1.

The regulator has at least one regulator stage 1 and the regulator taps in stage 1 are spaced between sets of windings with progressive windings ratios of 1 to 3 (the 3 iterated n times, where n is any integer) to 2. Thus, where n=1 and there are only three winding sets, the windings ratio is 1 to 3 to 2. Were n=2 the windings ratios are 1 to 3 to 3 to 2 and so forth.

Some regulators have a plurality of series connected regulator stages and each stage beyond stage 1 has at least one input tap with a windings ratio that is twice the sum of the stage 1 regulation steps, plus 1 additional step. So, if stage 1 has six regulation steps, the series connected stages will have a windings ratio equal to 13 steps. Each additional stage has a switch set whereby the regulation steps of stage 1 and any intervening stages are passed along in cascade to the next regulator stage in the plurality of stages to effect a number of regulations steps that is the series sum of the steps effected in each of the plurality of stages (see the various Tables and Figures for examples).

All disclosed switch matrices have logic control to effect the necessary switch openings and closings in the various disclosed embodiments to achieve the selected voltage regulation via the regulator. Advantageously, the logic control is embodied in micro-processor control logic modules, the construction and programming of which, in conjunction with the disclosure, will be within the reach of persons skilled in the art.

Disclosed regulators desirably employ switch logic for each stage that selectably effects one of three independent outcomes: adding all or parts of voltage associated with respective windings, subtracting all or parts of voltage associated with respective windings, and bypassing all windings in the stage to make no change in voltage. Each respective stage is independently controlled in a net summing manner to add to or subtract from a voltage being regulated.

### Null State and Commutation Examples

A switching matrix is disclosed that is operatively associated with a matrix of a plurality of voltage sources that have a collective and effective range of source voltages V between a V(low) and a V(high). The switching matrix has of a plurality of switches Q that are interposed between a voltage matrix line voltage V(return) and a voltage matrix output V(out). The switches are interposed between V(return) and V(out). The switching matrix has at least two pairs of switches Q(low)A Q(low)B and Q(high)A Q(high)B where each switch of a respective pair is individually commutated to function as a single bidirectional A B switch, and where each of the at least two pairs of A B switches is respectively connected to a separate voltage source, each source at or between V(low) and V(high). The pair of switches Q(low)A Q(low)B are connected at V(low) or at a lower end of the range between V(low) and V(high), and the pair of switches Q(high)A Q(high)B are connected at V(high) or at a higher end of the range between V(low) and V(high). The switching matrix includes a control module with a voltage polarity sensor and stored logic and instructions to effect a null state in the matrix. In the null state, when voltage polarity is positive, only Q(low)A and Q(high)B are turned on, and when voltage polarity is negative, only Q(high)A and Q(low)B are turned on, and during voltage polarity crossover, all four switches are turned on.

The matrix of a plurality of voltage sources may include independent voltage sources of a kind known to those skilled in the art (though any such sources are desirably in phase with each other or compatibly so, such as will occur to those skilled in the art), or one or more tap changing transformers, or a mixture of both.

Where the matrix of voltage sources includes a transformer having a plurality of voltage taps, the transformer has an effective tap changing voltage V range between a V(low) and a V(high).

The disclosed switching matrix can advantageously have at least one more pair of switches Q(1)A Q(1)B where this one more pair is also individually commutated to function as a single bidirectional A B switch, and where the one more pair is interposed between switches Q(low)A Q(low)B and Q(high)A Q(high)B and connected to a voltage tap V(1) separate from and interposed between V(low) and V(high). The control module has further logic and instructions to effect, when voltage V(1) is selected, all Q switches are set to off except the Q(high) and Q(low) switches and then both Q(1)A Q(1)B are turned on, regardless of whether voltage polarity is positive, negative, or during voltage polarity crossover.

Alternatively, the control module has further logic and instructions to effect instead, when voltage V(1) is selected, before both Q(1)A Q(1)B are set to on, an immediate transition through the matrix null state configuration (see Table 10 and discussion above). In many cases, this transition through the null state (see above) occurs whenever active switches (other than the Q(low)A Q(low)B and Q(high)A Q(high)B switches) are turned off. So in effect, when discussing a go-to null, there is a sense in which the matrix is always in that state, except that other switches are also turned on or off for the various voltage step selection switches. Turning off any active switches (except the Q(low)A Q(low)B and Q(high)A Q(high)B switches in their null state settings according to voltage polarity) is what puts the matrix in null state, and then other appropriate switches are turned on to deliver the selected voltage step from the appropriate voltage tap. Thus in effect, ‘exiting the null state’ is what is accomplished when new switches are turned on.

And alternate and compatible sense of the null state is when some combination of one or more of the Q(low)A Q(low)B and Q(high)A Q(high)B switches is always electrically conducting, (ie “on”). In other words, there is never a combination of all four switches that is off, except perhaps when the device is not in operation (turned off or out of the circuit), so there is always an electrically conducting path through those switches, wherein the matrix does not source any voltage nor drive any current, and wherein it clamps voltage when current is forced through it from a reactive load.

The switching matrix can also have four or more pairs of switches Q, where the fourth pair of switches Q( . . . n)A Q( . . . n)B is also individually commutated to function as a single bidirectional A B switch, and interposed between switches Q(1)A Q(1)B and Q(high)A Q(high)B and connected to a voltage tap V( . . . n) separate from and interposed between V(1) and V(high). The control module for this matrix configuration has further logic and instructions to effect, when voltage V( . . . n) is selected, but before both Q( . . . n)A Q( . . . n)B are turned on, all Q switches are set to off except both Q(high) and Q(low) switches, for an immediate transition through the null state matrix configuration and then both Q( . . . n)A Q( . . . n)B are set to on, regardless of whether voltage polarity is positive, negative, or during voltage polarity crossover.

### BRIEF DESCRIPTION OF THE DRAWINGS

FIG. 1 is a schematic representation of a range of conventional switches.

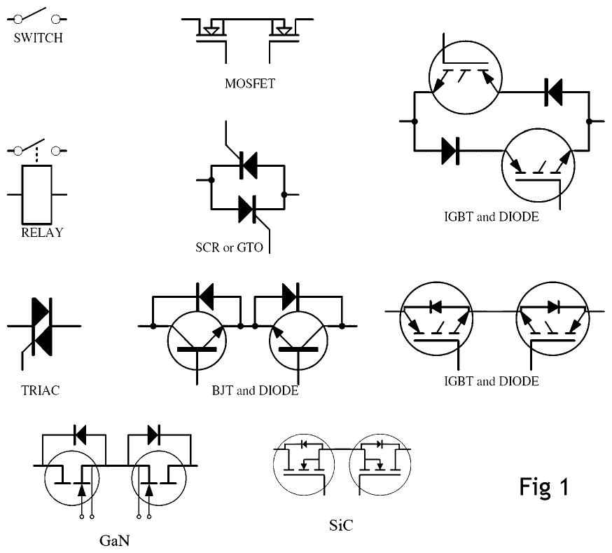

FIGS. 2A, 2B and 2C are schematic representations of known regulator switch topologies.

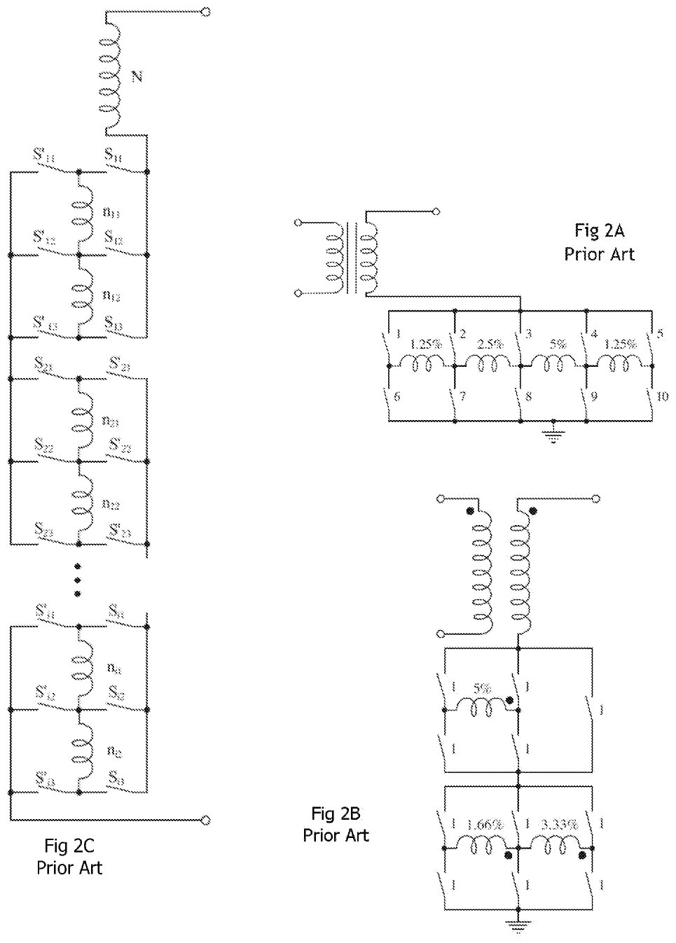

FIGS. 3A, 3B are schematic representations of known tap changing regulators.

FIG. 4 is a schematic representation of a unique topology disclosed herein.

FIG. 5 is a schematic representation of an example current path for the topology of FIG. 4.

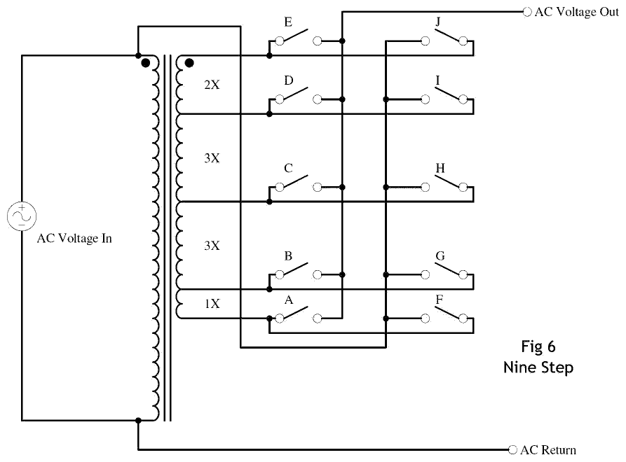

FIG. 6 is a schematic representation of an alternate unique topology disclosed herein.

FIG. 7 is a schematic representation of an alternate unique topology disclosed herein.

FIG. 8 is a schematic representation of an alternate unique topology disclosed herein.

FIG. 9 is a schematic view of further aspects of the disclosure.

FIGS. 10A, B are schematic views of further aspects of the disclosure.

FIG. 11 is a schematic of switch commutation aspects of the disclosure.

FIGS. 12A, 12B are schematics of switch commutation aspects of the disclosure.

### DETAILED DESCRIPTION

Turning now to the drawings, the invention will be described in a various embodiments by reference to the drawing figures and their parts.

Advantageously, disclosed multiple transformer tap change steps are contained in stages, such as 1×, 3×, 2× in a stage 1, and a second stage of 13×, with additional 13× stages optionally added as need. For each design the value of X is a variable which represents a fixed voltage value of a step change (the value is sometimes expressed as a percentage of the nominal input voltage) which is selectively configurable to meet the needs of the system into which the modules are installed. The switching stages are desirably arranged to cascade, meaning the stages are connected in series and the voltage step changes from one stage are passed along to the next stage before output.

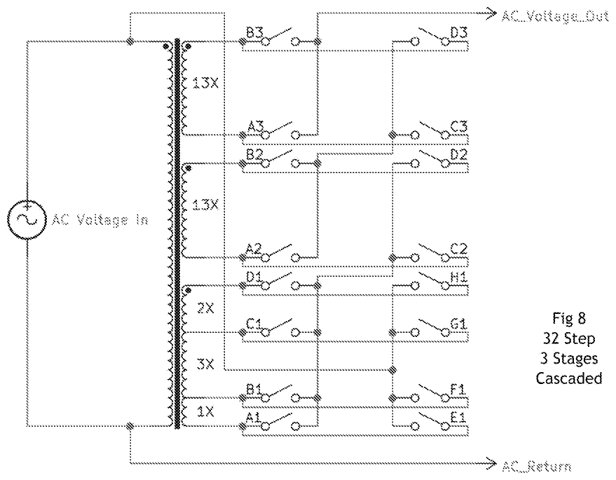

Each stage can selectably and independently produce one of three outcomes: it can add all, or for stages with multiple taps, parts of the voltage of its associated winding(s), it can subtract all (or parts) of the voltage of its associated winding(s), and it can bypass the winding(s) to make no change in voltage. For example, in FIG. 7 the implementation of 1 through 6 steps either boosting (plus) or bucking (minus) the output voltage, or no step change, are accomplished by stage 1. Stage 2 can only produce zero steps, add 13 steps, or subtract 13 steps. Stages are independently controlled, advantageously by microprocessor-operated switching logic, in a net summing manner, to add to or subtract from the voltage being regulated in order to achieve the desired result.

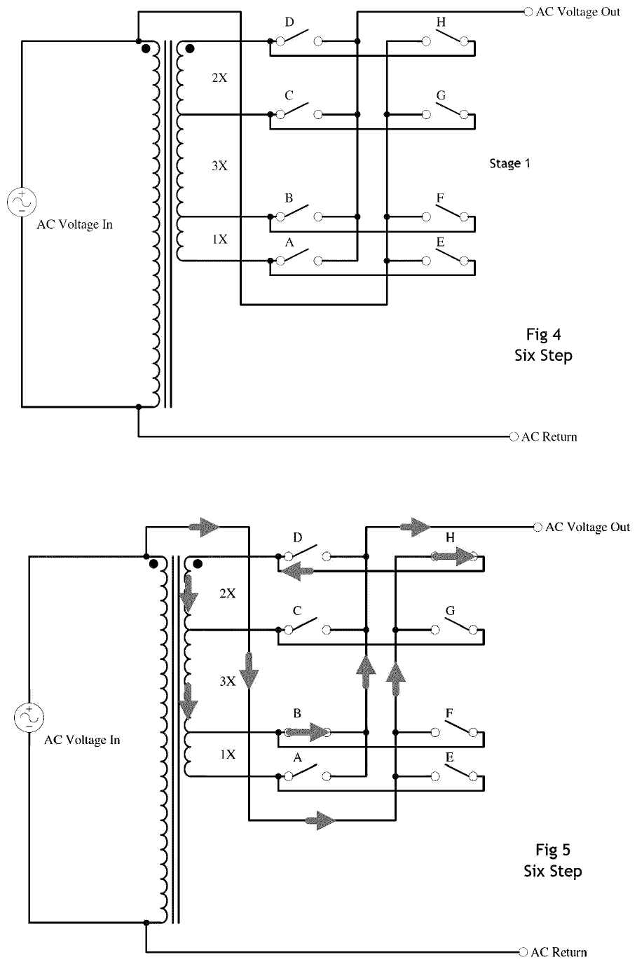

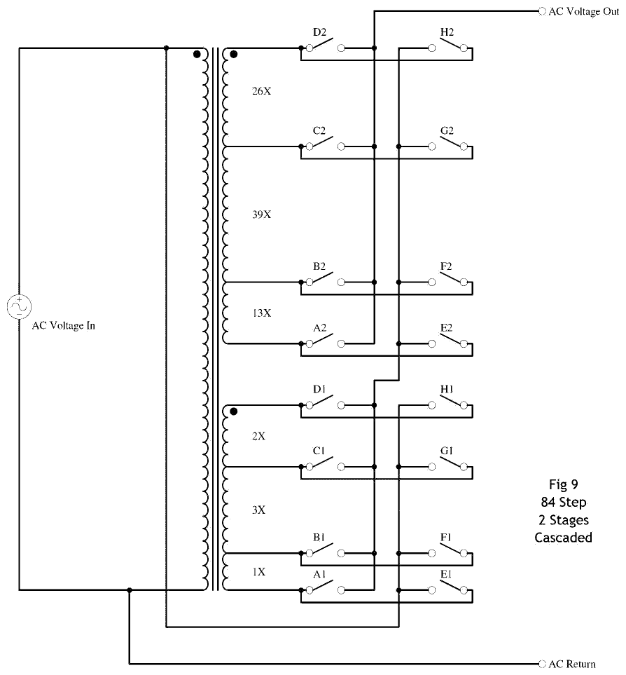

Each stage is comprised of a number of taps and related switches in accordance with the number of steps to be effected. For instance, steps of 1×, 3×, and 2× are advantageously configured in that order in one stage (see FIG. 4), sometimes referred to herein as stage 1. Where 13× modules (additional stages) are employed, they are advantageously used singly or in multiples (sometimes referred to herein as stage 2, stage 3, stage n, and the like). (FIG. 8 with its two 13× stages).

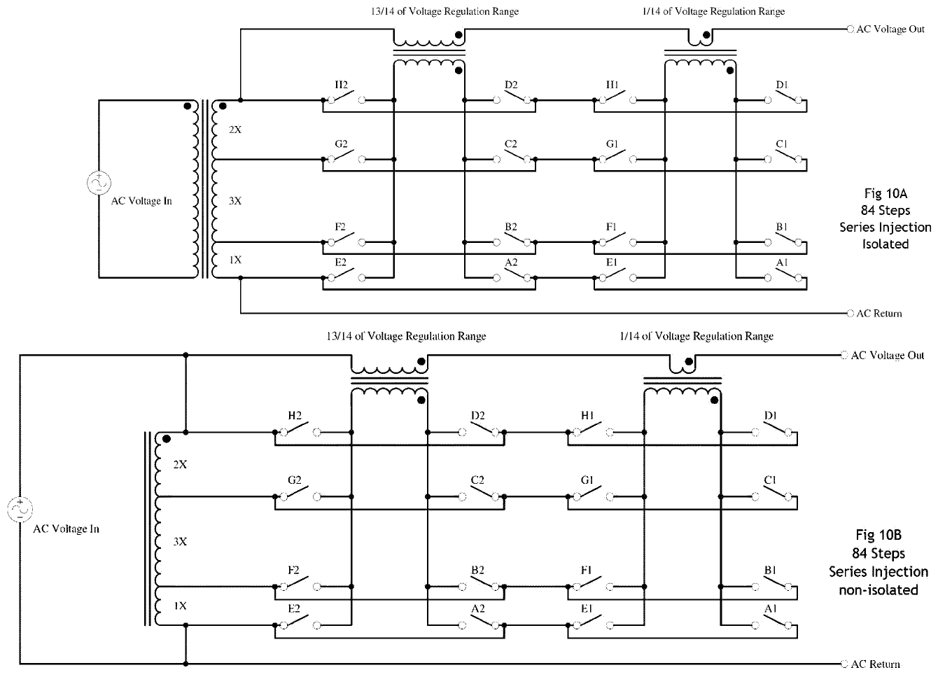

Advantageously, switches that are grouped together in the respective stages are of the same voltage rating. The number of stages employed is adaptable to system design goals. For instance, a low voltage regulator can group several steps in stage 2 (FIG. 9). In a medium voltage regulator the steps are separable into separate stages (where switch voltage ratings make such a separation advantageous). In such cases, it is advantageous for each stage to be individually fed by isolated transformer taps (FIG. 8).

Desirably, in effecting voltage step changes, pairs of switches are individually commutated to function as bidirectional switches. These bidirectional switches are controlled in accordance with the appropriate disclosed switching table to produce a plurality of positive or negative steps, either in sequence or non-sequential as desired. Advantageously this control is effected by microprocessor enabled automatic logic control. In such systems the appropriate switching table logic put into machine readable storage that is accessible to the microprocessor.

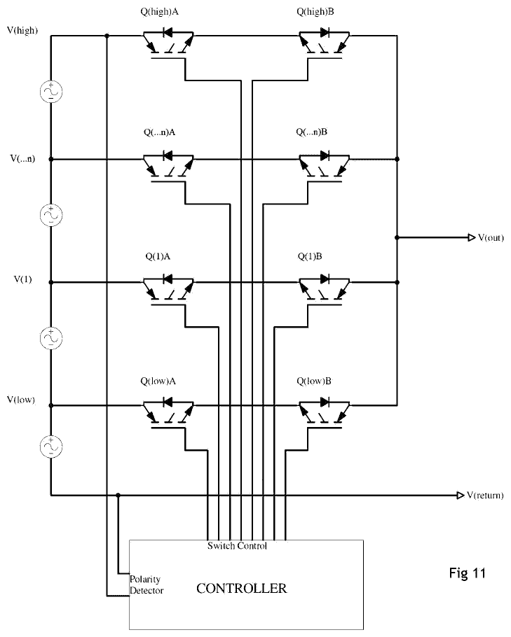

The steps are desirably powered by a multi-tapped transformer winding or other voltage source such as an isolated transformer or an auto transformer, or the like now known or later developed (see FIGS. 10A and 10B). The windings or turns ratio(s) of the output windings of the selected voltage source are effected in a manner that will be known to persons skilled in the art to produce these step voltages associated with the preferred turns ratio progression (see, for example, the 1×, 3×, 2×, 13×, 13× ratios illustrated in FIG. 8).

The 1/3/2 ratio progression is advantageous for disclosed devices and processes. This 1/3/2 ratio sequence is believed to best enable the series connected current path that effects sequential steps of 1 through 6. A 2/3/1 ratio may also be optionally applied, with suitable changes to switching tables and figures herein.

Similarly, if additional stages (2, 3 . . . n) are more than a single tap, their step ratios are also advantageously multiples of the desired 1/3/2 ratio sequence. For example, multiplying each ratio by 13× produces a turn ratio of 13/39/26) for a six step stage 1 as seen in FIG. 9 and Table 7.

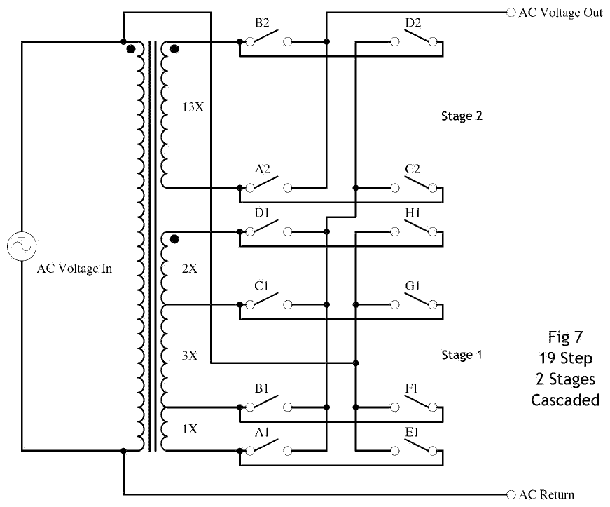

The desired 1/3/2 ratio sequence of a stage 1 can also be expanded beyond 6 steps by adding additional 3× taps (for example 1×, 3×, 3×, 2× for a 1/3/3/2 ratio set) which enables a 9 step stage 1, which is advantageously configured with a 19× Stage 2 (see FIG. 6 and Table 8). Further expansion to 1×, 3×, 3×, 3×, 2× (1/3/3/3/2) enables a 12 step stage 1, which is advantageously configured with a 25× Stage 2 (see Table 9). This sequence is further expandable in like manner as described above.

With a circuit designed to support a particular design specified current, the line voltage may be fed through separate stages in a cascading manner (in series) to individually add or subtract voltage supplied to the load (see FIGS. 7 & 8). In these examples the switches are isolated by the transformer and are floating at line potential relative to ground; therefore their voltage rating is advantageously linked to their respective tap voltage. The number of stage 2 or stage 3 switch modules employed in series is not limited, except as a practical matter by the voltage rating of the chosen switches and the degree of isolation of the switches from ground (assuming adequate heat sinking). Given these considerations, it is sometimes advantageous to use a single 26× stage in place of two 13× stages and similarly a single 39× stage in place of three 13× stages. See Tables 7, 8, and 9 for examples of these alternative configurations.

In practice, further design optimizations are effected either by varying the voltage value x of a step or varying the number of steps, or both. Selected optimizations achieve some or all of a combination of the following: optimizing the blocking voltages of the switches that collectively comprise each switching stage, adjusting the total percentage of Buck/Boost range, and adjusting the voltage change of each step.

### Examples

Voltage step x is set to a value of 0.316% of the nominal line voltage being regulated.

Thus a single 6 step stage 1 results in a +/−1.9% regulation range (see FIG. 4).

One six step stage 1 and one 13 step stage 2 effect a regulator with 19 steps and a +/−6% regulation range (see FIG. 7).

One six step stage 1 and two 13 step stages (stage 2, stage 3) effect a regulator with 32 steps and a +/−10% regulation range (see FIG. 8).

One six step stage 1 and three 13 step stages (stage 2, stage 3, stage 4) effect a regulator with 45 steps and a +/−14.2% regulation range. If the voltage of step x is adjusted down (such as by employing a different transformer tap turns ratio) from 0.316% to 0.222% of the nominal line voltage being regulated, the 45 step regulation range is reduced from 14.2% to a +/−10% regulation range.

Alternatively, and for designs requiring higher current, lower power switching modules may be employed to power the control winding (primary) of a series injection transformer as a means of adjusting the voltage to the load. In such an alternate design the current requirement of the switches is reduced in proportion to the turns ratio of the series injection transformer (see FIGS. 10A, 10B).

FIG. 4 shows one implementation of the disclosed micro-stepping cascading voltage regulator. It consists of a top winding with a voltage ratio of 2×, a bottom winding of 1×, and a middle winding of 3×. Using this configuration, a total range of +/−6 steps is effected as shown in switching Table 1.

TABLE 1
Switch closures for regulating +/− 6 steps (13 total steps with 8 switches).

| Step Value | Switches Closed |
|---|---|
| 0 | A-E, B-F, C-G or D-H |
| +1 | B-E |
| +2 | D-G |
| +3 | C-F |
| +4 | C-E |
| +5 | D-F |
| +6 | D-E |
| −1 | A-F |
| −2 | C-H |
| −3 | B-G |
| −4 | A-G |
| −5 | B-H |
| −6 | A-H |

A comparison of the number of taps and switches required by prior art and the current disclosure is shown in Table 2. A surprising and significant advantage is gained as the desired number of steps increases relative to the number of taps or switches even without cascading stages.

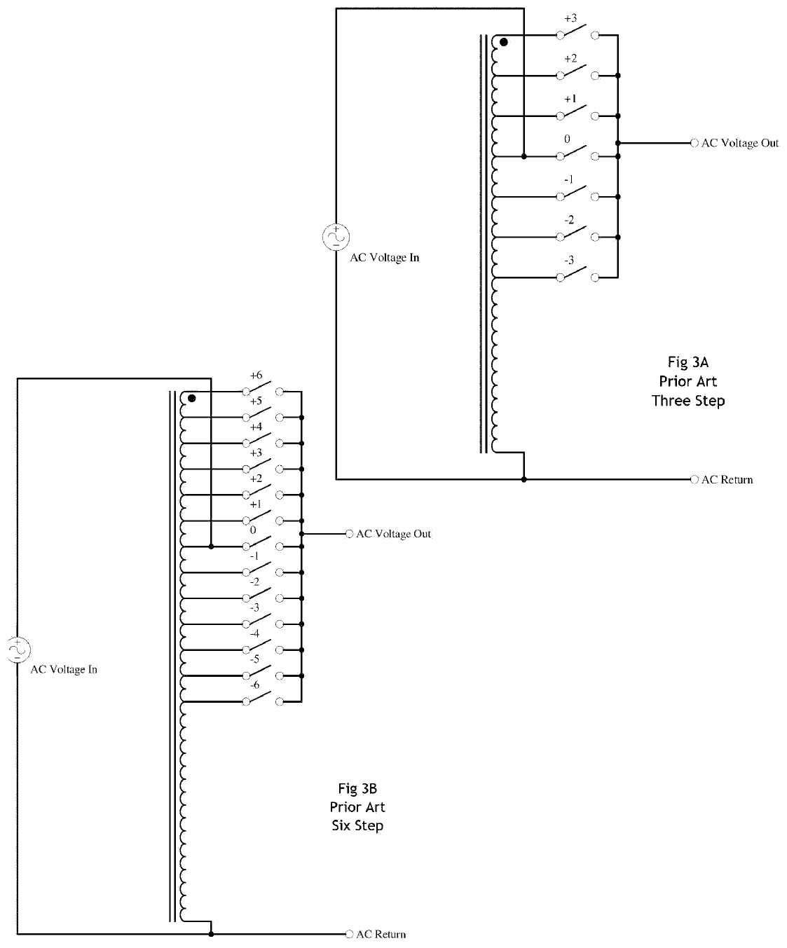

TABLE 2
Step to Tap ratio relative comparison

| | | | Step to Tap | No. of |
|---|---|---|---|---|
| Method | Step range | No. of taps | ratio | switches |
| FIG. 3B (Prior Art) | +/−6 steps | 13 | 0.46:1 | 13 |
| FIG. 4 | +/−6 steps | 4 | 1.5:1 | 8 |
| FIG. 6 | +/−9 steps | 5 | 1.8:1 | 10 |
| FIG. 7 | +/−19 steps | 6 | 3.1:1 | 12 |
| FIG. 8 | +/−32 steps | 8 | 4:1 | 16 |
| (Medium Voltage) | | | | |
| FIG. 9 | +/−84 steps | 8 | 10.5:1 | 16 |
| (Low Voltage) | | | | |

FIG. 6 shows another embodiment of the micro-stepping voltage regulator. This adds a second 3× winding in the middle, along with an additional pair of switches to Stage 1. This enables a total of ±/−9 steps with 10 switches as is shown in switching Table 3 below.

TABLE 3
Switch closures for regulating +/− 9 steps.

| Step Value | Switches Closed |
|---|---|
| 0 | A-F, B-G, C-H, D-I, or E-J |
| +1 | B-F |
| +2 | E-I |
| +3 | C-G or D-H |
| +4 | C-F |
| +5 | E-H |
| +6 | D-G |
| +7 | D-F |
| +8 | E-G |
| +9 | E-F |
| −1 | A-G |
| −2 | D-J |
| −3 | B-H or C-I |
| −4 | A-H |
| −5 | C-J |
| −6 | B-I |
| −7 | A-I |
| −8 | B-J |
| −9 | A-J |

It is further contemplated to insert an additional tap of 3× voltage steps to the transformer winding and 2 more bidirectional switches for a further increase of total number of steps to 12. These embodiments further increase in advantage over the prior art by cascading two or more regulator stages in series, effectively multiplying the steps with respect to the number of taps and switches.

FIG. 7 discloses a configuration with two stages cascaded together. More stages are cascaded for more total steps. FIG. 7 is a +/−6 step stage 1 combined with a 1 step stage 2. In this case, the single step stage 2 is 13× which is here advantageously paired with the 6 step stage. Total possible steps are +/−19 with 12 switches as shown below in switching Table 4.

TABLE 4
Switch closures for regulating +/− 19 steps.

| | | | | |
|---|---|---|---|---|
| Stage 1 | Stage 2 | | | |
| steps | steps | | Switches Closed | Switches Closed |
| (1X) | (13X) | Total steps | Stage 1 | Stage 2 |

Positive Steps

| | | | | |
|---|---|---|---|---|
| 0 | 0 | 0 | A1-E1 | A2-C2 |
| +1 | 0 | +1 | B1-E1 | A2-C2 |
| +2 | 0 | +2 | D1-G1 | A2-C2 |
| +3 | 0 | +3 | C1-F1 | A2-C2 |
| +4 | 0 | +4 | C1-E1 | A2-C2 |
| +5 | 0 | +5 | D1-F1 | A2-C2 |
| +6 | 0 | +6 | D1-E1 | A2-C2 |
| −6 | +1 | +7 | A1-H1 | B2-C2 |
| −5 | +1 | +8 | B1-H1 | B2-C2 |
| −4 | +1 | +9 | A1-G1 | B2-C2 |
| −3 | +1 | +10 | B1-G1 | B2-C2 |
| −2 | +1 | +11 | C1-H1 | B2-C2 |
| −1 | +1 | +12 | A1-F1 | B2-C2 |
| 0 | +1 | +13 | A1-E1 | B2-C2 |
| +1 | +1 | +14 | B1-E1 | B2-C2 |
| +2 | +1 | +15 | D1-G1 | B2-C2 |
| +3 | +1 | +16 | C1-F1 | B2-C2 |
| +4 | +1 | +17 | C1-E1 | B2-C2 |
| +5 | +1 | +18 | D1-F1 | B2-C2 |
| +6 | +1 | +19 | D1-E1 | B2-C2 |

Negative Steps

| | | | | |
|---|---|---|---|---|
| 0 | 0 | 0 | A1-E1 | A2-C2 |
| −1 | 0 | −1 | A1-F1 | A2-C2 |
| −2 | 0 | −2 | C1-H1 | A2-C2 |
| −3 | 0 | −3 | B1-G1 | A2-C2 |
| −4 | 0 | −4 | A1-G1 | A2-C2 |
| −. | 0 | −5 | B1-H1 | A2-C2 |
| −6 | 0 | −6 | A1-H1 | A2-C2 |
| +6 | −1 | −7 | D1-E1 | A2-D2 |
| +5 | −1 | −8 | D1-F1 | A2-D2 |
| +4 | −1 | −9 | C1-E1 | A2-D2 |
| +3 | −1 | −10 | C1-F1 | A2-D2 |
| +2 | −1 | −11 | D1-G1 | A2-D2 |
| +1 | −1 | −12 | B1-E1 | A2-D2 |
| 0 | −1 | −13 | A1-E1 | A2-D2 |
| −1 | −1 | −14 | A1-F1 | A2-D2 |
| −2 | −1 | −15 | C1-H1 | A2-D2 |
| −3 | −1 | −16 | B1-G1 | A2-D2 |
| −4 | −1 | −17 | A1-G1 | A2-D2 |
| −5 | −1 | −18 | B1-H1 | A2-D2 |
| −6 | −1 | −19 | A1-H1 | A2-D2 |

FIG. 8 has one +/−6 step stage 1 cascaded together with a 13× stage 2 and a 13× stage 3. Here the switches associated with the single 13× steps are separated into two stages (separate taps) in order to reduce the voltage rating requirement of the switches (compare with FIG. 9). Since the switches are isolated by the transformer and floating with respect to ground, the voltage across the switches is limited to the voltage across its associated winding. Total possible steps are +/−32 with 16 switches as shown below in switching Table 5 below.

TABLE 5
Switch closures for regulating +/−32 steps.

| | | | | | | |
|---|---|---|---|---|---|---|
| Stage 1 | Stage 2 | Stage 3 | | Switches | Switches | Switches |
| Steps | Steps | Steps | Total | Closed | Closed | Closed |
| (1X) | (13X) | (13X) | Steps | Stage1 | Stage 2 | Stage 3 |

Positive Steps

| | | | | | | |
|---|---|---|---|---|---|---|
| 0 | 0 | 0 | 0 | A1-E1 | A2-C2 | A3-C3 |
| +1 | 0 | 0 | 1 | B1-E1 | A2-C2 | A3-C3 |
| +2 | 0 | 0 | 2 | D1-G1 | A2-C2 | A3-C3 |
| +3 | 0 | 0 | 3 | C1-F1 | A2-C2 | A3-C3 |
| +4 | 0 | 0 | 4 | C1-E1 | A2-C2 | A3-C3 |
| +5 | 0 | 0 | 5 | D1-F1 | A2-C2 | A3-C3 |
| +6 | 0 | 0 | 6 | D1-E1 | A2-C2 | A3-C3 |
| −6 | +1 | 0 | 7 | A1-H1 | B2-C2 | A3-C3 |
| −5 | +1 | 0 | 8 | B1-H1 | B2-C2 | A3-C3 |
| −4 | +1 | 0 | 9 | A1-G1 | B2-C2 | A3-C3 |
| −3 | +1 | 0 | 10 | B1-G1 | B2-C2 | A3-C3 |
| −2 | +1 | 0 | 11 | C1-H1 | B2-C2 | A3-C3 |
| −1 | +1 | 0 | 12 | A1-F1 | B2-C2 | A3-C3 |
| 0 | +1 | 0 | 13 | A1-E1 | B2-C2 | A3-C3 |
| +1 | +1 | 0 | 14 | B1-E1 | B2-C2 | A3-C3 |
| +2 | +1 | 0 | 15 | D1-G1 | B2-C2 | A3-C3 |
| +3 | +1 | 0 | 16 | C1-F1 | B2-C2 | A3-C3 |
| +4 | +1 | 0 | 17 | C1-E1 | B2-C2 | A3-C3 |
| +5 | +1 | 0 | 18 | D1-F1 | B2-C2 | A3-C3 |
| +6 | +1 | 0 | 19 | D1-E1 | B2-C2 | A3-C3 |
| −6 | +1 | +1 | 20 | A1-H1 | B2-C2 | B3-C3 |
| −5 | +1 | +1 | 21 | B1-H1 | B2-C2 | B3-C3 |
| −4 | +1 | +1 | 22 | A1-G1 | B2-C2 | B3-C3 |
| −3 | +1 | +1 | 23 | B1-G1 | B2-C2 | B3-C3 |
| −2 | +1 | +1 | 24 | C1-H1 | B2-C2 | B3-C3 |
| −1 | +1 | +1 | 25 | A1-F1 | B2-C2 | B3-C3 |
| 0 | +1 | +1 | 26 | A1-E1 | B2-C2 | B3-C3 |
| +1 | +1 | +1 | 27 | B1-E1 | B2-C2 | B3-C3 |
| +2 | +1 | +1 | 28 | D1-G1 | B2-C2 | B3-C3 |
| +3 | +1 | +1 | 29 | C1-F1 | B2-C2 | B3-C3 |
| +4 | +1 | +1 | 30 | C1-E1 | B2-C2 | B3-C3 |
| +5 | +1 | +1 | 31 | D1-F1 | B2-C2 | B3-C3 |
| +6 | +1 | +1 | 32 | D1-E1 | B2-C2 | B3-C3 |

Negative Steps

| | | | | | | |
|---|---|---|---|---|---|---|
| 0 | 0 | 0 | −0 | A1-E1 | A2-C2 | A3-C3 |
| −1 | 0 | 0 | −1 | A1-F1 | A2-C2 | A3-C3 |
| −2 | 0 | 0 | −2 | C1-H1 | A2-C2 | A3-C3 |
| −3 | 0 | 0 | −3 | B1-G1 | A2-C2 | A3-C3 |
| −4 | 0 | 0 | −4 | A1-G1 | A2-C2 | A3-C3 |
| −5 | 0 | 0 | −5 | B1-H1 | A2-C2 | A3-C3 |
| −6 | 0 | 0 | −6 | A1-H1 | A2-C2 | A3-C3 |
| +6 | −1 | 0 | −7 | D1-E1 | A2-D2 | A3-C3 |
| +5 | −1 | 0 | −8 | D1-F1 | A2-D2 | A3-C3 |
| +4 | −1 | 0 | −9 | C1-E1 | A2-D2 | A3-C3 |
| +3 | −1 | 0 | −10 | C1-F1 | A2-D2 | A3-C3 |
| +2 | −1 | 0 | −11 | D1-G1 | A2-D2 | A3-C3 |
| +1 | −1 | 0 | −12 | B1-E1 | A2-D2 | A3-C3 |
| 0 | −1 | 0 | −13 | A1-E1 | A2-D2 | A3-C3 |
| −1 | −1 | 0 | −14 | A1-F1 | A2-D2 | A3-C3 |
| −2 | −1 | 0 | −15 | C1-H1 | A2-D2 | A3-C3 |
| −3 | −1 | 0 | −16 | B1-G1 | A2-D2 | A3-C3 |
| −4 | −1 | 0 | −17 | A1-G1 | A2-D2 | A3-C3 |
| −5 | −1 | 0 | −18 | B1-H1 | A2-D2 | A3-C3 |
| −6 | −1 | 0 | −19 | A1-H1 | A2-D2 | A3-C3 |
| +6 | −1 | −1 | −20 | D1-E1 | A2-D2 | A3-D3 |
| +5 | −1 | −1 | −21 | D1-F1 | A2-D2 | A3-D3 |
| +4 | −1 | −1 | −22 | C1-E1 | A2-D2 | A3-D3 |
| +3 | −1 | −1 | −23 | C1-F1 | A2-D2 | A3-D3 |
| +2 | −1 | −1 | −24 | D1-G1 | A2-D2 | A3-D3 |
| +1 | −1 | −1 | −25 | B1-E1 | A2-D2 | A3-D3 |
| 0 | −1 | −1 | −26 | A1-E1 | A2-D2 | A3-D3 |
| −1 | −1 | −1 | −27 | A1-F1 | A2-D2 | A3-D3 |
| −2 | −1 | −1 | −28 | C1-H1 | A2-D2 | A3-D3 |
| −3 | −1 | −1 | −29 | B1-G1 | A2-D2 | A3-D3 |
| −4 | −1 | −1 | −30 | A1-G1 | A2-D2 | A3-D3 |
| −5 | −1 | −1 | −31 | B1-H1 | A2-D2 | A3-D3 |
| −6 | −1 | −1 | −32 | A1-H1 | A2-D2 | A3-D3 |

FIG. 9 has one +/−6 step stage 1 cascaded together with a 3 step stage 2, which has a 13×, 39×, 26× ratio progression. Combining 3 taps into a single switching stage is desirably limited to low voltage designs where high resolution regulation is desired. Total possible steps are +/−84 with 16 switches as shown below in switching Table 6.

TABLE 6
Switch closures for regulating +/− 84 steps.

| | | | | |
|---|---|---|---|---|
| Stage 1 steps | Stage 2 steps | | Switches Closed | Switches Closed |
| (1X) | (13X) | Total steps | Stage 1 | Stage 2 |

Positive Steps

| | | | | |
|---|---|---|---|---|
| 0 | 0 | 0 | A1-E1 | A2-E2 |
| +1 | 0 | +1 | B1-E1 | A2-E2 |
| +2 | 0 | +2 | D1-G1 | A2-E2 |
| +3 | 0 | +3 | C1-F1 | A2-E2 |
| +4 | 0 | +4 | C1-E1 | A2-E2 |
| +5 | 0 | +5 | D1-F1 | A2-E2 |
| +6 | 0 | +6 | D1-E1 | A2-E2 |
| −6 | +1 | +7 | A1-H1 | B2-E2 |
| −5 | +1 | +8 | B1-H1 | B2-E2 |
| −4 | +1 | +9 | A1-G1 | B2-E2 |
| −3 | +1 | +10 | B1-G1 | B2-E2 |
| −2 | +1 | +11 | C1-H1 | B2-E2 |
| −1 | +1 | +12 | A1-F1 | B2-E2 |
| 0 | +1 | +13 | A1-E1 | B2-E2 |
| +1 | +1 | +14 | B1-E1 | B2-E2 |
| +2 | +1 | +15 | D1-G1 | B2-E2 |
| +3 | +1 | +16 | C1-F1 | B2-E2 |
| +4 | +1 | +17 | C1-E1 | B2-E2 |
| +5 | +1 | +18 | D1-F1 | B2-E2 |
| +6 | +1 | +19 | D1-E1 | B2-E2 |
| −6 | +2 | +20 | A1-H1 | D2-G2 |
| −5 | +2 | +21 | B1-H1 | D2-G2 |
| −4 | +2 | +22 | A1-G1 | D2-G2 |
| −3 | +2 | +23 | B1-G1 | D2-G2 |
| −2 | +2 | +24 | C1-H1 | D2-G2 |
| −1 | +2 | +25 | A1-F1 | D2-G2 |
| 0 | +2 | +26 | A1-E1 | D2-G2 |
| +1 | +2 | +27 | B1-E1 | D2-G2 |
| +2 | +2 | +28 | D1-G1 | D2-G2 |
| +3 | +2 | +29 | C1-F1 | D2-G2 |
| +4 | +2 | +30 | C1-E1 | D2-G2 |
| +5 | +2 | +31 | D1-F1 | D2-G2 |
| +6 | +2 | +32 | D1-E1 | D2-G2 |
| −6 | +3 | +33 | A1-H1 | C2-F2 |
| −5 | +3 | +34 | B1-H1 | C2-F2 |
| −4 | +3 | +35 | A1-G1 | C2-F2 |
| −3 | +3 | +36 | B1-G1 | C2-F2 |
| −2 | +3 | +37 | C1-H1 | C2-F2 |
| −1 | +3 | +38 | A1-F1 | C2-F2 |
| 0 | +3 | +39 | A1-E1 | C2-F2 |
| +1 | +3 | +40 | B1-E1 | C2-F2 |
| +2 | +3 | +41 | D1-G1 | C2-F2 |
| +3 | +3 | +42 | C1-F1 | C2-F2 |
| +4 | +3 | +43 | C1-E1 | C2-F2 |
| +5 | +3 | +44 | D1-F1 | C2-F2 |
| +6 | +3 | +45 | D1-E1 | C2-F2 |
| −6 | +4 | +46 | A1-H1 | C2-E2 |
| −5 | +4 | +47 | B1-H1 | C2-E2 |
| −4 | +4 | +48 | A1-G1 | C2-E2 |
| −3 | +4 | +49 | B1-G1 | C2-E2 |
| −2 | +4 | +50 | C1-H1 | C2-E2 |
| −1 | +4 | +51 | A1-F1 | C2-E2 |
| 0 | +4 | +52 | A1-E1 | C2-E2 |
| +1 | +4 | +53 | B1-E1 | C2-E2 |
| +2 | +4 | +54 | D1-G1 | C2-E2 |
| +3 | +4 | +55 | C1-F1 | C2-E2 |
| +4 | +4 | +56 | C1-E1 | C2-E2 |
| +5 | +4 | +57 | D1-F1 | C2-E2 |
| +6 | +4 | +58 | D1-E1 | C2-E2 |
| −6 | +5 | +59 | A1-H1 | D2-F2 |
| −5 | +5 | +60 | B1-H1 | D2-F2 |
| −4 | +5 | +61 | A1-G1 | D2-F2 |
| −3 | +5 | +62 | B1-G1 | D2-F2 |
| −2 | +5 | +63 | C1-H1 | D2-F2 |
| −1 | +5 | +64 | A1-F1 | D2-F2 |
| 0 | +5 | +65 | A1-E1 | D2-F2 |
| +1 | +5 | +66 | B1-E1 | D2-F2 |
| +2 | +5 | +67 | D1-G1 | D2-F2 |
| +3 | +5 | +68 | C1-F1 | D2-F2 |
| +4 | +5 | +69 | C1-E1 | D2-F2 |
| +5 | +5 | +70 | D1-F1 | D2-F2 |
| +6 | +5 | +71 | D1-E1 | D2-F2 |
| −6 | +6 | +72 | A1-H1 | D2-E2 |
| −5 | +6 | +73 | B1-H1 | D2-E2 |
| −4 | +6 | +74 | A1-G1 | D2-E2 |
| −3 | +6 | +75 | B1-G1 | D2-E2 |
| −2 | +6 | +76 | C1-H1 | D2-E2 |
| −1 | +6 | +77 | A1-F1 | D2-E2 |
| 0 | +6 | +78 | A1-E1 | D2-E2 |
| +1 | +6 | +79 | B1-E1 | D2-E2 |
| +2 | +6 | +80 | D1-G1 | D2-E2 |
| +3 | +6 | +81 | C1-F1 | D2-E2 |
| +4 | +6 | +82 | C1-E1 | D2-E2 |
| +5 | +6 | +83 | D1-F1 | D2-E2 |
| +6 | +6 | +84 | D1-E1 | D2-E2 |

Negative Steps

| | | | | |
|---|---|---|---|---|
| 0 | 0 | 0 | A1-E1 | A2-E2 |
| −1 | 0 | −1 | A1-F1 | A2-E2 |
| −2 | 0 | −2 | C1-H1 | A2-E2 |
| −3 | 0 | −3 | B1-G1 | A2-E2 |
| −4 | 0 | −4 | A1-G1 | A2-E2 |
| −5 | 0 | −5 | B1-H1 | A2-E2 |
| −6 | 0 | −6 | A1-H1 | A2-E2 |
| +6 | −1 | −7 | D1-E1 | A2-F2 |
| +5 | −1 | −8 | D1-F1 | A2-F2 |
| +4 | −1 | −9 | C1-E1 | A2-F2 |
| +3 | −1 | −10 | C1-F1 | A2-F2 |
| +2 | −1 | −11 | D1-G1 | A2-F2 |
| +1 | −1 | −12 | B1-E1 | A2-F2 |
| 0 | −1 | −13 | A1-E1 | A2-F2 |
| −1 | −1 | −14 | A1-F1 | A2-F2 |
| −2 | −1 | −15 | C1-H1 | A2-F2 |
| −3 | −1 | −16 | B1-G1 | A2-F2 |
| −4 | −1 | −17 | A1-G1 | A2-F2 |
| −5 | −1 | −18 | B1-H1 | A2-F2 |
| −6 | −1 | −19 | A1-H1 | A2-F2 |
| +6 | −2 | −20 | D1-E1 | C2-H2 |
| +5 | −2 | −21 | D1-F1 | C2-H2 |
| +4 | −2 | −22 | C1-E1 | C2-H2 |
| +3 | −2 | −23 | C1-F1 | C2-H2 |
| +2 | −2 | −24 | D1-G1 | C2-H2 |
| +1 | −2 | −25 | B1-E1 | C2-H2 |
| 0 | −2 | −26 | A1-E1 | C2-H2 |
| −1 | −2 | −27 | A1-F1 | C2-H2 |
| −2 | −2 | −28 | C1-H1 | C2-H2 |
| −3 | −2 | −29 | B1-G1 | C2-H2 |
| −4 | −2 | −30 | A1-G1 | C2-H2 |
| −5 | −2 | −31 | B1-H1 | C2-H2 |
| −6 | −2 | −32 | A1-H1 | C2-H2 |
| +6 | −3 | −33 | D1-E1 | B2-G2 |
| +5 | −3 | −34 | D1-F1 | B2-G2 |
| +4 | −3 | −35 | C1-E1 | B2-G2 |
| +3 | −3 | −36 | C1-F1 | B2-G2 |
| +2 | −3 | −37 | D1-G1 | B2-G2 |
| +1 | −3 | −38 | B1-E1 | B2-G2 |
| 0 | −3 | −39 | A1-E1 | B2-G2 |
| −1 | −3 | −40 | A1-F1 | B2-G2 |
| −2 | −3 | −41 | C1-H1 | B2-G2 |
| −3 | −3 | −42 | B1-G1 | B2-G2 |
| −4 | −3 | −43 | A1-G1 | B2-G2 |
| −5 | −3 | −44 | B1-H1 | B2-G2 |
| −6 | −3 | −45 | A1-H1 | B2-G2 |
| +6 | −4 | −46 | D1-E1 | A2-G2 |
| +5 | −4 | −47 | D1-F1 | A2-G2 |
| +4 | −4 | −48 | C1-E1 | A2-G2 |
| +3 | −4 | −49 | C1-F1 | A2-G2 |
| +2 | −4 | −50 | D1-G1 | A2-G2 |
| +1 | −4 | −51 | B1-E1 | A2-G2 |
| 0 | −4 | −52 | A1-E1 | A2-G2 |
| −1 | −4 | −53 | A1-F1 | A2-G2 |
| −2 | −4 | −54 | C1-H1 | A2-G2 |
| −3 | −4 | −55 | B1-G1 | A2-G2 |
| −4 | −4 | −56 | A1-G1 | A2-G2 |
| −5 | −4 | −57 | B1-H1 | A2-G2 |
| −6 | −4 | −58 | A1-H1 | A2-G2 |
| +6 | −5 | −59 | D1-E1 | B2-H2 |
| +5 | −5 | −60 | D1-F1 | B2-H2 |
| +4 | −5 | −61 | C1-E1 | B2-H2 |
| +3 | −5 | −62 | C1-F1 | B2-H2 |
| +2 | −5 | −63 | D1-G1 | B2-H2 |
| +1 | −5 | −64 | B1-E1 | B2-H2 |
| 0 | −5 | −65 | A1-E1 | B2-H2 |
| −1 | −5 | −66 | A1-F1 | B2-H2 |
| −2 | −5 | −67 | C1-H1 | B2-H2 |
| −3 | −5 | −68 | B1-G1 | B2-H2 |
| −4 | −5 | −69 | A1-G1 | B2-H2 |
| −5 | −5 | −70 | B1-H1 | B2-H2 |
| −6 | −5 | −71 | A1-H1 | B2-H2 |
| +6 | −6 | −72 | D1-E1 | A2-H2 |
| +5 | −6 | −73 | D1-F1 | A2-H2 |
| +4 | −6 | −74 | C1-E1 | A2-H2 |
| +3 | −6 | −75 | C1-F1 | A2-H2 |
| +2 | −6 | −76 | D1-G1 | A2-H2 |
| +1 | −6 | −77 | B1-E1 | A2-H2 |
| 0 | −6 | −78 | A1-E1 | A2-H2 |
| −1 | −6 | −79 | A1-F1 | A2-H2 |
| −2 | −6 | −80 | C1-H1 | A2-H2 |
| −3 | −6 | −81 | B1-G1 | A2-H2 |
| −4 | −6 | −82 | A1-G1 | A2-H2 |
| −5 | −6 | −83 | B1-H1 | A2-H2 |
| −6 | −6 | −84 | A1-H1 | A2-H2 |

The number of steps is advantageously increased even more by using stages with more steps, or by cascading more stages. Various alternate configurations are shown in the tables below. Other configurations, with the teachings herein, will occur to those skilled in the art.

TABLE 7
Configuration examples based on a 6 step Stage 1

| | | | | | Number of | |
|---|---|---|---|---|---|---|
| | | | | # | Bidirectional | FIG. |
| 6 STEP - Stage 1 | Stage 2 | Stage 3 | Steps+/− | Taps | Switches | Ref |
| 1 (1x, 3x, 2x) | | | 6 | 4 | 8 | FIG. 4 |
| 1 (1x, 3x, 2x) | 1 (13x) | | 19 | 6 | 12 | FIG. 7 |
| 1 (1x, 3x, 2x) | 2 (13x) | | 32 | 8 | 16 | FIG. 8 |
| 1 (1x, 3x, 2x) | 3 (13x) | | 45 | 10 | 20 | none |
| 1 (1x, 3x, 2x) | 1 (13x, 39x, 26x) | | 84 | 8 | 16 | FIG. 9 |
| 1 (1x, 3x, 2x) | 1 (13x, 39x, 26x) | 1 (169x, 507x, 338x) | 1098 | 12 | 24 | none |

TABLE 8
Configuration examples based on a 9 step Stage 1

| | | | | | | |
|---|---|---|---|---|---|---|
| | | | | | Number of | |
| | | | | | Bidirectional | Figure |
| 9 STEP - Stage 1 | Stage 2 | Stage 3 | Steps+/− | # Taps | Switches | Ref |

| | | | | | |
|---|---|---|---|---|---|
| 1 (1x, 3x, 3x, 2x) | | 9 | 5 | 10 | FIG. 6 |
| 1 (1x, 3x, 3x, 2x) | 1 (19x) | 28 | 7 | 14 | none |
| 1 (1x, 3x, 3x, 2x) | 2 (19x) | 47 | 9 | 18 | none |
| 1 (1x, 3x, 3x, 2x) | 1 (19x, 57x, 57x, 38x) | 180 | 10 | 20 | none |

TABLE 9
Configuration examples based on a 12 step Stage 1

| | | | | | | |
|---|---|---|---|---|---|---|
| | | | | | Number of | |
| | | | | Number | Bidirectional | Figure |
| 12 STEP - Stage 1 | Stage 2 | Stage 3 | Steps+/− | of Taps | Switches | Ref |

| | | | | | |
|---|---|---|---|---|---|
| 1 (1x, 3x, 3x, 3x, 2x) | | 12 | 6 | 12 | none |
| 1 (1x, 3x, 3x, 3x, 2x) | 1 (25x) | 37 | 8 | 16 | none |
| 1 (1x, 3x, 3x, 3x, 2x) | 2 (25x) | 62 | 10 | 20 | none |
| 1 (1x, 3x, 3x, 3x, 2x) | 1 (25x, 75x, 50x) | 162 | 10 | 20 | none |

Two further embodiments are shown in FIGS. 10A and 10B. These use a common set of input taps to power both stages of the cascade. Each stage employs its own series injection transformer to regulate the output. These series injection transformers are sized in ratio and voltage output to add and subtract as previously shown. One advantage of these configurations is to effect a high current regulator using lower current switches.

FIG. 10A shows an isolated +/−84 step regulating transformer which is useful in a utility application with a low or medium voltage input. FIG. 10B shows a low voltage, non-isolated +/−84 step regulator, which is useful to regulate AC voltage of a building or buildings, or regulating low to medium voltage AC branch circuits. The voltage taps in this case are advantageously provided by an autotransformer.

Advantageously, the various illustrated and tabularized switch topologies and on-off states are controlled by a microprocessor employing a set of instructions, including stored switching table logic, that are executed such that switch states in a given topology and voltage and/or current conditions in the respective topology are continuously monitored in real time so that switch states are changed instantaneously (delays desirably in the order of single digit microseconds) in response to changing voltage and/or current conditions to achieve design requirements.

Depending on the turns ratios of the transformer taps, the various stages will operate at different voltages and power levels. For instance, a stage 1 will typically operate at the lowest voltage and current, enabling the use of smaller and lower cost switches.

Disclosed technology is implemented in either single phase or three phase applications. For three phase voltage regulation in Wye configurations, the transformer which supplies the switching stages is connected Line to Neutral. In Delta configurations the equivalent of a grounding transformer is employed to provide a neutral connection. Alternatively, if the transformer which supplies the switching stages is connected Line to Line the device will effect a variable phase shift, in a manner appreciated by persons skilled in the art.

In a utility application, disclosed topologies replace prior art tap changing line regulators for voltage regulation and stabilization of the grid. With the large number of available steps, the step size can readily be made small enough to enable use as a network control transformer to control power flow between various feeders and interconnections within the grid. This represents an alternative to the tap changing phase angle shifting methods conventionally employed.

Alternately, with the large number of available steps, extremely wide (+/−50% or more) total regulation range may be effected, while maintaining relatively tight regulation. Thus, disclosed topologies are effective as DVRs (Dynamic Voltage Restorers). Response time to control inputs is limited only by speed of particular switches. For some applications, at steady state the regulator will only occasionally change steps. In transient conditions, it will change steps multiple times within a line cycle (if so desired and so programmed) using the commutation methodology further disclosed herein. There is no limitation to the frequency of adjustment other than speed and allowable switching losses in the electronic switches, as will be appreciated by those skilled in the art.

Because of this, in addition to RMS voltage regulation, the disclosed technology provides the ability to adjust or correct voltage harmonics and THD by tap selection at various points within a line cycle. It will effect ripple signal (AFLC) communications on the grid by modulating at various predetermined frequencies (typically between 175 and 1750 Hz). Depending on the control loop, it will also dampen or null out such frequencies as might exist on the grid so as not to disturb sensitive loads.

Power flow is advantageously bidirectional in all the various embodiments. Thus, a configuration is implemented in either direction or in alternating directions in response to power changing from positive to negative and vice-versa. Voltage sensing is advantageously employed on both sides of the regulator to accomplish this.

Various other voltage or current control methods may optionally be employed to control the switches in the manner disclosed for similar or different results as will be appreciated by those skilled in the art. These include analog, digital, and mixed signal implementations. They also include variations in analog logic or microprocessor control. In some cases, it may be possible and advantageous to control the disclosed regulation manually.

### Method of Commutation

Switch commutation is accomplished by a variety of methods in AC-AC converters. Often, switches are commutated in a break before make sequence. During the break time, peak voltages are controlled by a variety of voltage clamps, snubbers, or other similar devices. However, to minimize voltage stress on the power switches and reduce switching losses, an improved commutation method as disclosed below is desirable.

U.S. Pat. No. 5,747,972 (MicroPlanet '972), incorporated herein by reference as if fully set forth, describes a commutation method that eliminates the need for voltage clamps and snubbers. However, it has two shortcomings. This '972 method can switch only between two voltage levels, and because of that it requires high speed pulse width modulation (PWM) to create intermediate voltages between a low and high AC voltage input. This increases both electromagnetic interference and losses. The '972 method also lacks an effective high impedance, or OFF mode; that is, the output is either low, high, or modulated somewhere in between.

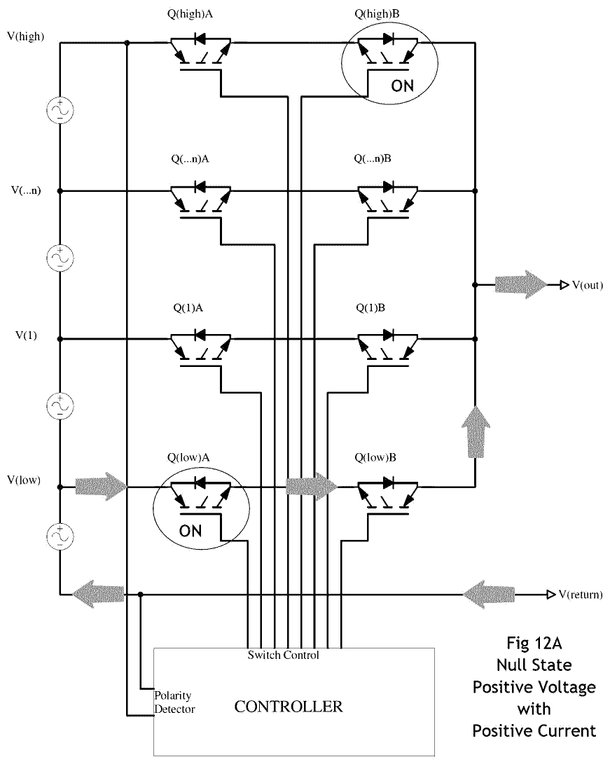

FIG. 11 shows a circuit for changing taps between any number of AC voltage levels. These voltages are supplied either by independent AC sources, or from multiple taps of a transformer or autotransformer. They are of equal or varying potential in step size. The only requirements are that they are in phase, and that the intermediate voltages (V(1), V( . . . n)) are between V(high) and V(low) in potential. Intermediate voltage sources number from 0 to any desired number for desired range and resolution. For example, substitute the four pairs of switches shown in FIG. 11 for switches A1, B1, C1, D1 in FIG. 7. This method also applies to switching between voltage taps in a traditional tap changing transformer.

Control logic and methodology is described in Table 10 below. Control circuitry senses input voltage and polarity and responds to positive input voltage or negative input voltage as well as input voltage polarity crossover (X). Switches are either off (0) or on (1) according to Table 10.

TABLE 10
Commutation Switching Matrix

| | Line | | | | | | | | |
|---|---|---|---|---|---|---|---|---|---|
| | Polarity | Q(high)A | Q(high)B | Q(1)A | Q(1)B | Q(. . . n)A | Q(. . . n)B | Q(low)A | Q(low)B |
| Null | + | 0 | 1 | 0 | 0 | 0 | 0 | 1 | 0 |
| State | − | 1 | 0 | 0 | 0 | 0 | 0 | 0 | 1 |
| | X | 1 | 1 | 0 | 0 | 0 | 0 | 1 | 1 |
| V(high) | + | 1 | 1 | 0 | 0 | 0 | 0 | 1 | 0 |
| | − | 1 | 1 | 0 | 0 | 0 | 0 | 0 | 1 |
| | X | 1 | 1 | 0 | 0 | 0 | 0 | 1 | 1 |
| V(. . . n) | + | 0 | 1 | 0 | 0 | 1 | 1 | 1 | 0 |
| | − | 1 | 0 | 0 | 0 | 1 | 1 | 0 | 1 |
| | X | 1 | 1 | 0 | 0 | 1 | 1 | 1 | 1 |
| V(1) | + | 0 | 1 | 1 | 1 | 0 | 0 | 1 | 0 |
| | − | 1 | 0 | 1 | 1 | 0 | 0 | 0 | 1 |
| | X | 1 | 1 | 1 | 1 | 0 | 0 | 1 | 1 |
| V(low) | + | 0 | 1 | 0 | 0 | 0 | 0 | 1 | 1 |
| | − | 1 | 0 | 0 | 0 | 0 | 0 | 1 | 1 |
| | X | 1 | 1 | 0 | 0 | 0 | 0 | 1 | 1 |

The purpose of this method is to commutate between multiple switches quickly and reliably so there is no excessive voltage across any of the switches, switching losses are minimized, and without need of external voltage limiting clamps, snubbers, or similar circuitry. Note that Null State does not source any voltage and therefore will not drive any current; however it does clamp voltage if, for instance, current is forced through it from a reactive load.

Discussion of the disclosed method begins with a method base state, referred to herein as the null state. With the switches oriented in this state, no voltage is transferred to the output except during crossover (the voltage zero crossing). To avoid cross conduction, the crossover state typically occurs within approximately +/−4V of the actual voltage zero crossing for IGBTs and approximately +/−2V for MOSFET and BJT circuits and the like.

An advantage of the null state is that even though no input voltage is transferred to the output, output current (such as back feed from a load) during this mode is clamped by the high and low switches so that no switch experiences overvoltage.

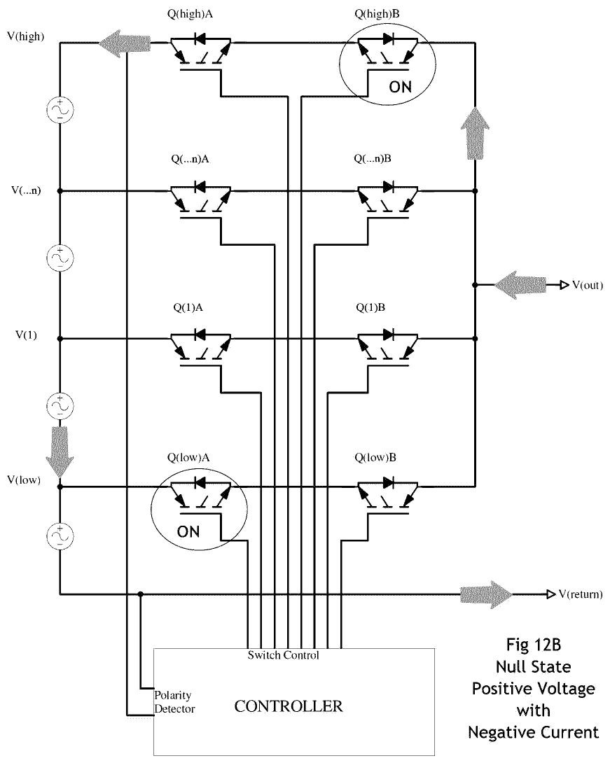

For example, consider the null state with positive input voltage polarity in FIG. 11. During this period, only Q(low)A and Q(high)B are turned on. If the reactive load current is positive (see FIG. 12A), with Q(low)A on, the current conducts through Q(low)A switch and Q(low)B diode. V(out) is clamped effectively to V(low). If the reactive load current is negative (see FIG. 12B), with Q(high)B on, the current conducts through Q(high)B switch and Q(high)A diode. V(out) is clamped to V(high).

V(out) and V(return) can be connected directly to a load or connected in series with an additional transformer winding or other voltage source, in order to raise or lower the voltage, as will be appreciated by those skilled in the art.

Null state is an especially useful feature when paralleling transformers or regulators fed from a common sources or separate sources, particularly when one regulator is already in operation. A second regulator can be hot switched in parallel with a first regulator if it is in null state and if the first regulator voltage is greater than V(low) and less than V(high). Once regulators are connected, appropriate taps are selected to achieve current sharing among two or more regulators.

Another useful feature of null state is that it is useful to prioritize two parallel voltage sources in terms of providing load support in lieu of a transfer switch. Consider a critical load being served by two separate line sources (each desirably having the same phase). One feeder serving as the primary source, and the second as a standby source, both are connected to the load through the switch matrix shown in FIG. 11. The primary source is engaged in active regulation, and the standby is held in the null state. The primary source provides power to the load until its output voltage drops (from line impedance drops, faults, or failure) below V(low) of the standby source. At that point, the standby source begins to source current to the load, and the primary source is then held in the null state. The standby source now takes over regulating the voltage to the load. This provides for seamless transition to the standby source. The null state also allows the standby source to be powered up and connected without having to supply load current during the power up operation.

To begin voltage transfer to the output, starting from null state, any of the voltage levels desired are applied to the output by simply activating the appropriate switches as shown in Table 10. To switch from one level to another requires only a temporary transition back to null state, and then to the next desired level. The transition time is short, depending upon switch speed. For an IGBT circuit, it would typically be from one to several microseconds in null state before switching to the next level. In some embodiments, the transition into and out of null state may be advantageously effected by simply effecting a turn-off of all of the Table 10 switches except those which are set for the positive and negative null state (thus desirably effecting an instantaneous null state) and then an immediate turn-on of the Table 10 switches required to effect the next desired V level.

By this method, switching between V levels is readily made at any point in the line cycle, or at multiple points in the line cycle, with greatly reduced switching losses compared with prior art implementations. A regulator thus responds instantaneously to load or control requirements. It also responds quickly and effectively during output overload and/or the onset of transformer core saturation, thus further improving system reliability.

Switching between V levels is made at a variety of desired rates, times, or frequencies. Steady state operation often requires minimal switching of levels, such as an occasional switch during voltage fluctuations. However, switching will occur multiple times per line cycle if desired to respond quickly to fast transients. Accordingly, a regulator that employs this commutation methodology is capable of true sub cycle response.

A further benefit of this method is that different voltage levels are optionally employed on positive half cycles versus negative half cycles. Thus, the disclosed regulator enables inducing a desired DC voltage offset in the power line, as well as nulling an existing DC voltage offset.

If desired, high frequency PWM techniques are optionally employed to provide output voltage levels between taps. High frequency switching between two taps allows for a smaller and less expensive output filter compared to switching between only two voltages as shown in prior art.

Since AC voltage levels provided by multiple taps on a transformer or autotransformer are subject to leakage inductances inherent in transformers, an AC filter capacitor is desirably placed between successive taps for high frequency filtering.

In compliance with the statute, the invention has been described in language more or less specific as to structural features. It is to be understood, however, that the invention is not limited to the specific features shown, since the means and construction shown comprise advantageous forms of putting the invention into effect. The invention is, therefore, claimed in any of its forms or modifications within the legitimate and valid scope of the appended claims, appropriately interpreted in accordance with the doctrine of equivalents.

We claim:

1. A tap changing regulator comprising at least one regulator stage, the at least one regulator stage further comprising a set of input taps and a set of switches in a switching matrix, the switches selectively and individually engagable in respective on-off modes to operably connect one or more of the taps to an output voltage to effect a number of regulation steps.

2. The regulator of claim 1 wherein a ratio of the number of regulation steps to the number of taps in the at least one regulator stage is greater than 1:1.

3. The regulator of claim 1 wherein the at least one regulator stage is stage 1 and the regulator taps in stage 1 are spaced between sets of windings having a respective set of progressive windings ratios of 1 to (3 iterated n times, where n is any integer) to 2

4. The regulator of claim 3 wherein n=1 and the progressive windings ratios are 1 to 3 to 2.

5. The regulator of claim 3 wherein n=2 and the progressive windings ratios are 1 to 3 to 3 to 2.

6. The regulator of claim 3 further comprising a plurality of series connected regulator stages, each stage beyond stage 1 having at least one input tap having a windings ratio that is twice the sum of the stage 1 regulation steps, plus 1 additional step, and further having a switch set whereby the regulation steps of stage 1 and any intervening stages are passed along in cascade to the next regulator stage in the plurality of stages to effect a number of regulations steps that is the series sum of the steps effected in each of the plurality of stages.

7. The regulator of claim 3 wherein n=1 and the progressive windings ratios are 1 to 3 to 2 and the at least one input tap of the next stage in series has a windings ratio of 13.

8. The regulator of claim 1 wherein switch logic for the stage selectably effects one of three independent outcomes selected from the group of outcomes consisting of: adding all or parts of voltage associated with respective windings, subtracting all or parts of voltage associated with respective windings, and bypassing all windings in the stage to make no change in voltage.

9. The regulator of claim 3 wherein switch logic for each stage can respectively and selectably effect one of three independent outcomes selected from the group of outcomes consisting of: adding all or parts of voltage associated with respective windings, subtracting all or parts of voltage associated with respective windings, and bypassing all windings in the stage to make no change in voltage, where each respective stage is independently controlled and in a net summing manner to add to or subtract from a voltage being regulated.

10. A switching matrix operatively associated with a matrix of a plurality of voltage sources having an effective range of source voltages V between a V(low) and a V(high), the switching matrix comprised of a plurality of switches Q and interposed between a voltage matrix line voltage V(return) and a voltage matrix output V(out), the switching matrix comprising:
a plurality of switches Q interposed between V(return) and V(out);
the switching matrix further comprising at least two pairs of switches Q(low)A Q(low)B and Q(high)A Q(high)B where each switch comprising a respective pair is individually commutated to function as a single bidirectional A B switch, and where each of the at least two pairs of A B switches is respectively connected to a separate voltage source, each source at or between V(low) and V(high);
wherein the pair of switches Q(low)A Q(low)B are connected at a lower end of the range between V(low) and V(high) and the pair of switches Q(high)A Q(high)B are connected at a higher end of the range between V(low) and V(high);
the switching matrix further comprising a control module having a voltage polarity sensor and stored logic and instructions to effect a null state in the matrix, whereby when voltage polarity is positive, only Q(low)A and Q(high)B are turned on, and when voltage polarity is negative, only Q(high)A and Q(low)B are turned on, and during voltage polarity crossover, all four switches being turned on.

11. The switching matrix operatively associated with a matrix of a plurality of voltage sources of claim 10, wherein the matrix of the plurality of voltage sources is a matrix comprised, at least in part, of independent voltage sources.

12. The switching matrix operatively associated with a matrix of a plurality of voltage sources of claim 10, wherein the matrix of the plurality of voltage sources is a matrix comprised, at least in part, of a transformer having a plurality of voltage taps, the transformer having an effective tap changing voltage V range between a V(low) and a V(high)

13. The switching matrix operatively associated with a transformer having a plurality of voltage taps of claim 12, the switching matrix further comprising at least one more pair of switches Q(1)A Q(1)B where this one more pair is also individually commutated to function as a single bidirectional A B switch, and where the one more pair is interposed between switches Q(low)A Q(low)B and Q(high)A Q(high)B and connected to a voltage tap V(1) separate from and interposed between V(low) and V(high);
the control module containing further logic and instructions to effect, when voltage V(1) is selected, all Q switches are set to off except the Q(high) and Q(low) switches and then both Q(1)A Q(1)B are turned on, regardless of whether voltage polarity is positive, negative, or during voltage polarity crossover.

14. The switching matrix operatively associated with a transformer having a plurality of voltage taps of claim 13, the control module containing further logic and instructions to effect instead, when voltage V(1) is selected, before both Q(1)A Q(1)B are set to on, an immediate transition through the matrix null state configuration.

15. The switching matrix operatively associated with a transformer having a plurality of voltage taps of claim 12, the switching matrix further comprising at least four pairs of switches Q, the at least fourth pair of switches Q( . . . n)A Q( . . . n)B, where this fourth pair is also individually commutated to function as a single bidirectional A B switch, and where the fourth pair is interposed between switches Q(1)A Q(1)B and Q(high)A Q(high)B and connected to a voltage tap V( . . . n) separate from and interposed between V(1) and V(high);
the control module containing further logic and instructions to effect, when voltage V( . . . n) is selected, but before both Q( . . . n)A Q( . . . n)B are turned on, all Q switches are set to off except both Q(high) and Q(low) switches for an immediate transition through the null state matrix configuration and then both Q( . . . n)A Q( . . . n)B are set to on, regardless of whether voltage polarity is positive, negative, or during voltage polarity crossover.

16. A switching matrix operatively associated with a transformer having a plurality of voltage taps, the transformer having an effective tap changing voltage V range between a V(low) and a V(high), the matrix capable of a Null State, the matrix comprising, in the Null State:
a switching matrix comprised of a plurality of switches Q and interposed between a transformer line voltage V(return) and a transformer output V(out);
wherein the matrix does not source any voltage nor drive any current, and wherein it clamps voltage when current is forced through it from a reactive load.
